(19) United States
(12) Patent Application Publication
(10) Pub. No.: US 2003/0056629 A1
(43) Pub. Date: Mar. 27, 2003

(54) Constant chip volume cutting system for machine tools

(75) Inventors: Antonio Battistella, Brendola (VI) (IT); Riccardo Campion, Brendola (VI) (IT); Giuseppe Fin, Brendola (VI) (IT); Marco Gabrielli, Brendola (VI) (IT)

Correspondence Address: John S. Egbert, Harrison & Egbert, 7th Floor, 412 Main Street, Houston, TX, 77002, US

(73) Assignee: SINICO SPA, Brendola (VI) (IT)

(21) Appl. No.: 10/214,953

(22) Filed: Aug. 8, 2002

(30) Foreign Application Priority Data
Sep. 7, 2001 (IT) TV2001A000121

(51) Int. Cl. B26D 7/06

(52) U.S. Cl. 83/100

(57) ABSTRACT

Constant chip volume cutting system for machine tools, which includes at least one cut-off phase of a tube or round bar, in which the advancement speed of the cut-off unit, which is guided by a logic-control unit, is continuously and regularly adapted, to keep the volume of chip cut away and accumulated in each gap between the teeth of the blade constant, due to the fact that, when cutting a bar, the advancement speed will be higher at the beginning and at the end of the cut, and lower in the central part.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The object of this invention is a constant chip volume cutting system for machine tools.

The proposal may be particularly, but not necessarily exclusively, used in the sector concerning the automatic machining of both tubular and solid metal bars on work centers.

### BACKGROUND OF THE INVENTION

The machining of metal bars is widely used. It usually involves the end of the piece to be machined, and involves operations such as squaring off, internal end external chamfering, internal and external threading and so on.

Since the work is carried out in an automatic cycle, the bars to be machined, either tubular or solid, are usually loaded onto the machine tool. Therefore, the first step to be carried out is to either cut or shear the piece which is to be later machined.

The various following steps are carried out on fixed work stations, while the piece to be machined is transferred cyclically to each station by means of a rotating table, known as a transfer table.

As described previously, the first step of the work cycle is the cutting of the tubular or solid bar, because, only once the cutting cycle has been carried out, the rotating table to which the cut piece is fixed is able to transfer it to the front of the other peripheral stations for the successive cycles.

In order to obtain the highest productivity possible, the common goal of the manufacturers of automatic machine tools is, therefore, to reduce the time required for the various operations to a minimum, particularly the cutting or shearing phase of the bar as described above and which, in the solution described herein, is carried out before all the other operations.

However, reducing the time required means that the working life of the cutting tool is reduced, which in the case being examined is a disk-type cutter. Therefore, because of the costs involved for the purchase and replacement of the blade, and the resulting down times of the machine tool in order to carry out the operation, it has become indispensable to identify work techniques aimed at reaching the best compromise between the working life of the blade and the time required for the cutting phase.

The blade is made up of a series of teeth or cutters, situated around the circumference at a certain pitch, and in most cases the pitch is constant.

One of the main causes of wear to the blade is the vibration induced by the interrupted cutting action along the whole of the cutting machine, that is, from the moment in which the cutting disk comes into contact with the surface of the piece up to the moment in which the cut is completed. Therefore, in order to reduce the vibrations, the ideal solution would be a blade with an infinite number of cutting edges.

From a practical point of view, this solution would not be possible because the cutting speed would have to be too high. In spite of this, we can safely say that ideal cutting conditions are closely reached when the increase in the number of teeth is compatible with the cutting speed.

On the other hand, we must also take into consideration the fact that, with a high number of teeth, the space or gap between one tooth and another is reduced, with the risk that the chips accumulate in the gaps with an excessive volume of material. These conditions give rise to friction between the blade, tooth and chip, which leads to excessive wear of the blade.

During the cutting phase of a solid bar, for example, since any one of the teeth of the blade (which rotates at a constant speed) cuts arcs of material with varying lengths, according to whether the cutting phase is at the beginning (small arcs of material are cut) or at the center of the piece (the largest arcs of material are cut), it is clear that the material accumulated between one tooth and another will be either more or less, respectively, at the center (contact arc between the blade and piece to be cut is large) and at the beginning (contact arc between the blade and piece to be cut is small). The same conditions are obviously found when cutting a tubular piece of material.

In view of the above considerations, it is clear that one way of reducing or increasing the chip volume accumulated in the gaps is to reduce or increase the advancement speed of the cutting machine shaft, while keeping the cutting speed, that is the rotation speed, constant.

Therefore, to sum up, in a work center with a traditional cut-off unit, which is the type most commonly found, the advancement speed is kept constant. On the other hand, in the more advanced types of equipment, the piece is cut in steps, usually three, according to the point in which it is to be found.

Generally speaking, it may be said that traditional solutions are still a long way from optimum cutting conditions. The conditions are somewhat limited, since they must satisfy the requirements mentioned previously of a compromise which, on the one hand, safeguard the working life of the blade, while on the other hand, penalize the time required to carry out the cutting cycle.

To sum up, the cutting systems used up until now never achieve the result of reducing the time required for cutting as much as possible compared with a determined wear level, which may be considered normal.

In consideration of the above, it seems quite clear that alternative and more functional solutions compared with those available or deduced up until now must be found.

The aim of this invention is, therefore, to offer the market a solution which gives greater satisfaction to the buying public.

### BRIEF SUMMARY OF THE INVENTION

These and other aims are achieved by means of the invention contained herein, according to the characteristics in the attached claims, by solving the problems described by means of a constant chip volume cutting system for machine tools which includes at least one cutting phase of a tube or round bar, in which the advancement speed of the cut-off machine, guided by a logic-control unit, is continuously and regularly adapted, to keep the volume of chip removed and accumulated in each of the gaps between the teeth constant since, when cutting a bar, the advancement speed is higher at the start and at the end of the cut and lower in the middle part.

In this way, by means of the significant creative content, which leads to an immediate technical progress, various objectives are reached.

Firstly, the time required for cutting is considerably reduced compared with the use of standard equipment.

It is worth pointing out that the reduction in the time required is achieved with any diameter of blade or bar to be cut.

To sum up, it is now possible to have a machine with a high technological content and with a system which is able to reduce the time required for cutting, while keeping as close as possible to the optimum cutting conditions and, consequently, obtaining a longer working life of the blade compared with previous solutions.

These and other advantages will be shown in the following detailed description and attached drawings of at least one preferential application of the solution, the details of which are intended to be an example and not a limitation.

### BRIEF DESCRIPTION OF THE SEVERAL VIEWS OF THE DRAWINGS

FIG. 1 is a graph illustration which represents the comparison between the movement of the cutting machine shaft according to the cutting technique used with a standard cut (1), and the movement of the cutting machine shaft according to the cutting technique proposed in the invention (2). The analysis was carried out by cutting a 50 mm diameter tube with a wall thickness of 8 mm.

FIG. 2 is another graph illustration which represents the comparison between the time required to carry out the cutting phase according to the cutting technique used with a standard cut (1), and the time required to carry out the cutting phase according to the cutting technique proposed in the invention (2). The analysis was carried out by cutting a 50 mm diameter tube with a wall thickness of 8 mm.

FIG. 3 is yet another graph illustration which represents the comparison between the volume of chip accumulated inside each gap according to the cutting technique used with a standard cut (1), and the volume of chip accumulated inside each gap according to the cutting technique proposed in the invention (2). The analysis was again carried out by cutting a 50 mm diameter tube with a wall thickness of 8 mm.

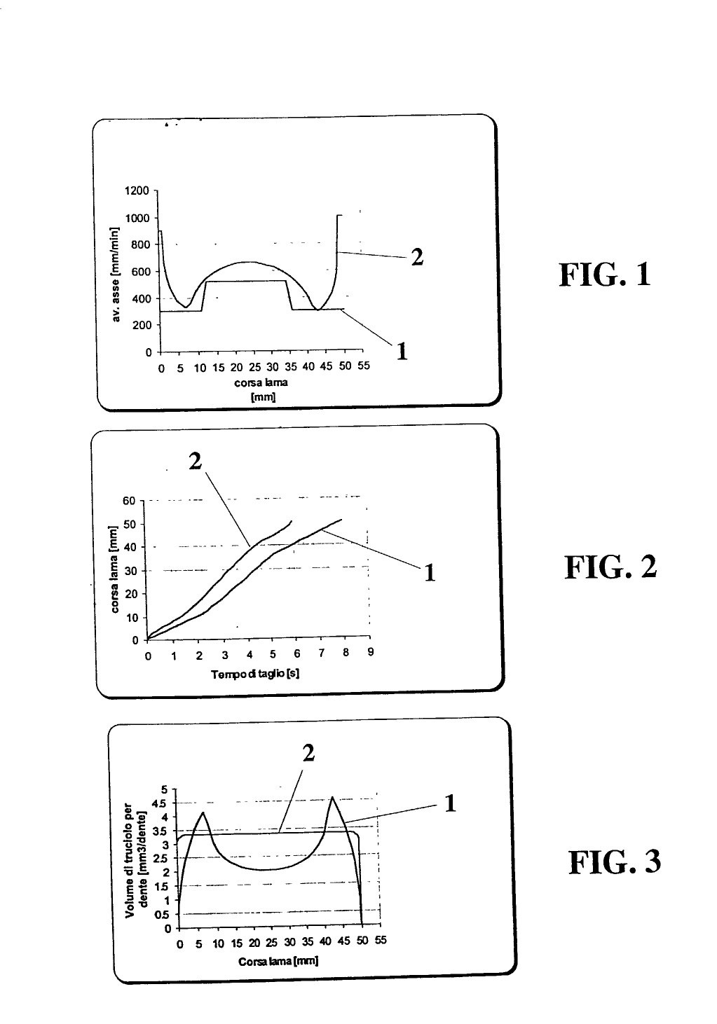

### DETAILED DESCRIPTION OF THE INVENTION

With reference to the illustrations, it is shown that the aim of the invention is to allow the advancement speed of the cutting machine shaft to be varied, in order to keep the volume of chip cut away by each tooth constant.

The first consideration to be made is that the volume of chip which is cut away by each tooth of the blade is measured in [mm³/tooth], and the equation used, which is stored in the logic-control unit of the machine tool, is schematically shown below:

q=ARC×S×az

where, q=the volume of chip accumulated between two teeth of the blade [mm³/tooth]; ARC=the arc which results from the intersection between the average circumference of the blade and the circular piece to be cut (mm); S=thickness of the disk (mm); and Az=advancement per tooth of the shaft of the cut-off machine (mm/tooth).

As far as the thickness of the disk is concerned, this is a known value since it may be assumed that, in relation to the operation to be carried out, the disk to be used has already been chosen.

The intersection arc is found by means of a mathematical relationship obtained through the equation of the circumference of the blade and the circumference of the round bar to be cut, according to the point in which the blade is to be found inside the bar. In this way, the equation ARC=f(x) is obtained, where x is the position of the blade. In this case, x=“0” with the blade at the start of the cut, and x=“bar diameter” with the blade at the end of the cut.

The volume of chip cut away, “q”, which must remain constant, is calculated by assuming that the blade is in a maximum cutting condition, that is, on the diameter of the solid bar (or, in the case of a tube, inside the wall of the tube with the blade at a tangent with respect to the hole). Under these conditions, the value which represents the advancement per tooth “az” is introduced and “q” is calculated according to the previous equation.

According to the diameter of the bar to be cut, a sample of various points along the cut is created, from “0” up to the point in which the diameter of the bar is reached, and the following formula is applied:

az=q/(ARC×S)

The real advancement, in order to determine the movement of the shaft of the cut-off unit, is given by the formula:

a=az×z×n

where: a=real advancement of the cut-off unit [mm/min]; z=number of cutting edges on the blade (known value); and n=rotation speed of the blade (revs/min) (known value).

We claim:

1. Constant chip volume cutting system for machine tools, which include at least one cut-off phase of a tube or round bar, where the following values are known:
z=number of cutting edges on the blade;
n=rotation speed of the blade (revs/min);
az=advancement speed per tooth of the shaft of the cut-off unit (mm/tooth)
characterized by the fact that the advancement speed of the cut-off unit, which is guided by a logic-control unit, is continuously and regularly adapted, to keep the volume of chip accumulated in each gap between the teeth of the blade constant, due to the fact that the following formula is inserted:
a=az×z×n
with: a=real advancement of the cut-off unit in [mm/min]

2. Constant chip volume cutting system characterized by the fact that the advancement per tooth of the shaft of the cut-off unit is determined by the relationship
az=q/(ARC×S)
where:
q=the volume of chip accumulated between two teeth of the blade [mm³/tooth];
ARC=the arc which results from the intersection between the average circumference of the blade and the circular piece to be cut (mm);
S=thickness of the disk (mm); and
az=advancement speed per tooth of the shaft of the cut-off unit (mm/tooth).

3. Constant chip volume cutting system for machine tools characterized by the fact that the volume of chip cut away by each tooth of the blade in [mm³/tooth] is given by:
q=ARC×S×az

4. Constant chip volume cutting system for machine tools characterized by the fact that the advancement speed of the cut-off unit, which is guided by a logic-control unit, is continuously and regularly adapted, to keep the volume of chip accumulated in each gap between the teeth of the blade constant, due to the fact that, when cutting a bar, the advancement speed will be higher at the beginning and at the end of the cut, and lower in the central part.
